(19) United States
(12) Patent Application Publication
(10) Pub. No.: US 2016/0285138 A1
(43) Pub. Date: Sep. 29, 2016

(54) PORTABLE ENERGY-STORAGE DEVICE WITH UNIVERSAL INPUT/OUTPUT POWER INTERFACE

(71) Applicant: NATIONAL CHUNG SHAN INSTITUTE OF SCIENCE AND TECHNOLOGY, Taoyuan City (TW)

(72) Inventors: Chih-Peng LIU, Taoyuan City (TW); Hsun-Ming HSIEN, Taoyuan City (TW); Fu-Min FANG, Taoyuan City (TW)

(21) Appl. No.: 14/822,990

(22) Filed: Aug. 11, 2015

(30) Foreign Application Priority Data
Mar. 27, 2015 (TW) 104109894

(51) Int. Cl. H01M 10/46; H02J 7/00; H02J 7/35

(52) U.S. Cl. CPC H01M 10/465; H01M 10/46; H02J 7/355; H02J 7/0021; H02J 7/0026

(57) ABSTRACT

A portable energy-storage device includes a battery module unit for storing and outputting electrical power; a power switch unit connected to the battery module unit to enable or disable the operations of the portable energy-storage device; a universal I/O power interface unit connected to the power switch unit to store and output electrical power; a power level monitoring unit connected to the power switch unit to monitor a power level of the battery module unit; a power level display unit for displaying a power level status of the battery module unit; and a protection switch control unit connected to the battery module unit and the power level monitoring unit. The power level monitoring unit signals the protection switch control unit to disable the operations of the portable energy-storage device so as to against damage caused by under-discharging and/or over-charging the battery module unit.

### CROSS-REFERENCE TO RELATED APPLICATION

This non-provisional application claims priority under 35 U.S.C. §119(a) on Patent Application No(s). 104109894 filed in Taiwan, R.O.C. on Mar. 27, 2015, the entire contents of which are hereby incorporated by reference.

### FIELD OF THE INVENTION

The present invention relates to the field of energy storage and power supply and, more particularly, to a portable energy-storage device capable of storing electrical energy and supplying power.

### BACKGROUND OF THE INVENTION

Nowadays, portable electronic products, such as smartphones, tablets, digital cameras and so forth, are in wide use and thus closely tied with our daily life. Since the rated capacity of batteries built in portable electronic products are never unlimited, long operation sessions of the portable electronic products are subject to energy limitations. To solve this problem, users carry mobile power banks outdoors to extend the operation sessions of the portable electronic products.

At present, diesel generators are utilized at venues which require intensive mobile power supply, such as peddler-oriented markets, construction sites, ad hoc military commands, and disaster rescue centers, to provide large-power supply and enable long-use applications. However, to address issues like global fossil energy resource shortage, escalating demand for energy consumption reduction and carbon reduction, and increasingly strict legal requirements for noise and air pollution, not only do most users switch gradually to portable energy-storage devices, but governments also pass laws and offer promotional allowances which encourage consumers to opt for eco-friendly energy-storage products. In view of this, the trend toward the use and production of eco-friendly products is inevitable.

Commercially available portable energy storage devices have to come with power converter units as needed. For instance, small-sized portable energy-storage devices mostly use a USB or Micro USB as a conversion interface. To meet various power requirements, large-sized portable energy-storage devices require to built-in multiple power converters and related interfaces, thereby leading to an increase in the required hardware volume and weight, compromising portability, and adding to product costs.

### SUMMARY OF THE INVENTION

According to the aforesaid drawbacks of the prior art, the present invention provides a portable energy-storage device which comprises a universal input/output(I/O) power interface without any other built-in power converters. If the universal I/O power interface is designed to be cigarette lighter receptacles, people are allowed to purchase and carry commercially available vehicular electronic devices as needed and use them anytime and anywhere. The portable energy-storage device of the present invention can operate independently. In another embodiment, the portable energy-storage devices of the present invention are connected in series for a variety of power demands. In a variant embodiment, the portable energy-storage devices of the present invention are connected in parallel for a variety of power demands.

The present invention provides a portable energy-storage device, comprising: a battery module unit for storing and outputting electrical power; a power switch unit connected to the battery module unit and adapted to enable or disable the operations of the portable energy-storage device; at least a universal I/O power interface unit connected to the power switch unit and adapted to not only output electrical power of the battery module unit but also store electrical power in the battery module unit; a power level monitoring unit connected to the power switch unit and adapted to monitor a power level of the battery module unit; and a protection switch control unit connected to the battery module unit and the power level monitoring unit, wherein the power level monitoring unit signals the protection switch control unit to disable the operations of the portable energy-storage device so as to protect the portable energy-storage device against the damage caused by the under-discharging and/or over-charging of the battery module unit.

### BRIEF DESCRIPTION OF THE DRAWINGS

Objectives, features, and advantages of the present invention are hereunder illustrated with specific embodiments in conjunction with the accompanying drawings, in which:

FIG. 1 is a schematic view of the systemic framework of a portable energy-storage device of the present invention;

FIG. 2 is a perspective view of the portable energy-storage device according to the first embodiment of the present invention;

FIG. 3 is a perspective view of a portable energy-storage device according to the second embodiment of the present invention; and

FIG. 4 is a perspective view of a portable energy-storage device according to the third embodiment of the present invention.

### DETAILED DESCRIPTION OF THE PREFERRED EMBODIMENTS

To render the features and advantages of the present invention more obvious and comprehensible, the present invention is hereunder illustrated with specific embodiments and a detailed description.

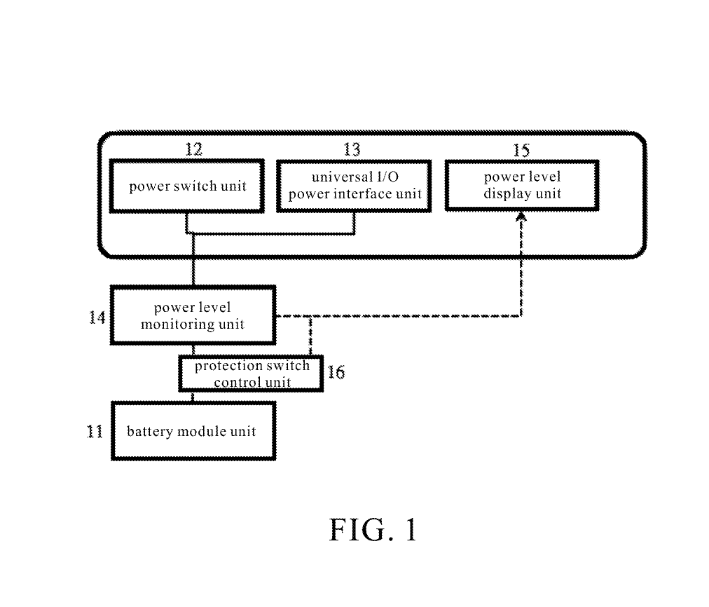

Referring to FIG. 1, there is shown a schematic view of the systemic framework of a portable energy-storage device according to an embodiment of the present invention. As shown in the diagram, the portable energy-storage device according to an embodiment of the present invention comprises a battery module unit 11, a power switch unit 12, at least a universal I/O power interface unit 13, and a protection switch control unit 16. The battery module unit 11 is adapted for storing and outputting electrical power. The power switch unit 12 is electrically connected to the battery module unit 11 and adapted to enable or disable the operations of the portable energy-storage device. The at least a universal I/O power interface unit 13 is electrically connected to the power switch unit 12 and adapted to output the electrical power of the battery module unit 11 or deliver the electrical power from an external power source to the battery module unit 11 for storage. The power level monitoring unit 14 is electrically connected to the power switch unit 12. The power level monitoring unit 14 monitors the power level of the battery module unit 11 and generates a power level signal. Referring to FIG. 1, the portable energy-storage device according to an embodiment of the present invention further comprises a power level display unit 15 which is connected to the power level monitoring unit 14 to receive the power level signal from the power level monitoring unit 14 and display the power level status of the battery module unit 11. The protection switch control unit 16 is electrically connected to the battery module unit 11 and the power level monitoring unit 14. The power level monitoring unit 14 signals the protection switch control unit 16 to disable the operations of the portable energy-storage device so as to protect the portable energy-storage device against the damage caused by under-discharging and/or over-charging the battery module unit 11. The protection switch control unit 16 is a relay, a MOSFET, an IGBT or any electronic component capable of switching.

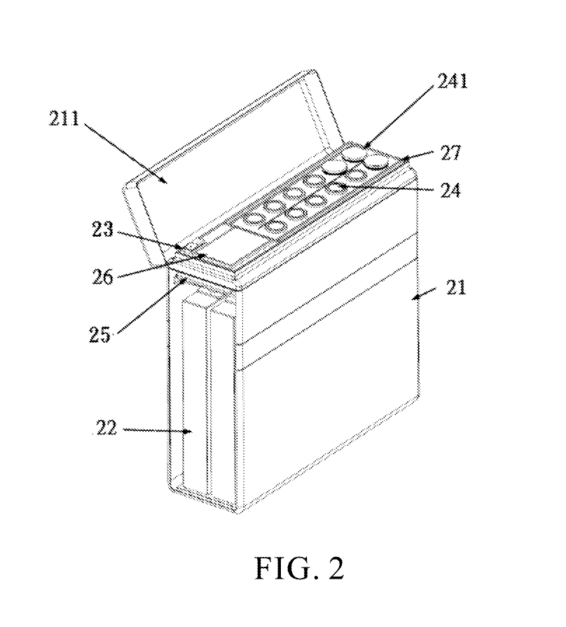

Referring to FIG. 2, there is shown a perspective view of the portable energy-storage device according to the first embodiment of the present invention. In the first embodiment of the present invention, the portable energy-storage device comprises: a casing 21 for containing the constituent elements of the portable energy-storage device; a battery module unit 22 composed of one or more batteries; a power switch unit 23 connected to the battery module unit 22 to allow users to enable or disable the operations of the portable energy-storage device; at least a universal I/O power interface unit 24 connected to the power switch unit 23 and adapted to output the electrical power of the battery module unit 22 or transfer electrical power from an external source to the battery module unit 22 for storage; a power level monitoring unit 25 connected to the power switch unit 23 and adapted to monitor the power level of the battery module unit 22 and transmit a power level signal; and a power level display unit 26 connected to the power level monitoring unit 25 and adapted to receive the power level signal from the power level monitoring unit 25 and display the power level status of the battery module unit 22 and the operation status of the portable energy-storage device. The universal I/O power interface unit 24, the power switch unit 23 and the power level display unit 26 are disposed on a control panel 27. The control panel 27, the power level monitoring unit 25 and the battery module unit 22 are disposed in the casing 21. The casing 21 has a protective lid 211 for concealing and protecting the control panel unit 27 against dust, rainwater, salty fog and so on and preventing the users from electrical shocks. Each universal I/O power interface unit 24 has a protective cap 241 for covering the universal I/O power interface unit 24 to serve a protective and insulating purpose.

The portable energy-storage device of the present invention is characterized in that the universal I/O power interface unit is a cigarette lighter receptacle. Therefore, any commercially available vehicular electronic products using cigarette lighter plugs as power conversion interfaces are directly utilized with the portable energy-storage device. The portable energy-storage device of the present invention is applied to various commercially available products such as a vehicular inverter, a power converter, a lighter, a charger, an air purifier, a vacuum cleaner, an electric inflator, a rescue cable, a power rescuer, and so on. The universal I/O power interface unit of the present invention can also be applied to a USB receptacle or any other power I/O conversion interfaces in a customized manner. In practice, in case of insufficient power loading of one receptacle of a single universal I/O power interface unit, it is practicable for multiple universal I/O power interface units to be connected in parallel to thereby prevent the connection lines from being burnt due to an overly high power. The universal input/output interface unit has two polarities, that is, a positive pole and a negative pole. In a variant embodiment of the present invention, the universal input/output interface unit is a connector with a single polarity.

When charging, the portable energy-storage device of the present invention uses the same universal I/O power interface unit such that the users can perform the charging operation with an external power or solar charger. The external power is connected to a charger through utility power supply so as to charge the battery module unit of the present invention directly. When the portable energy-storage device of the present invention is operating outdoors and has access to sunlight, the universal I/O power interface unit is connected to a solar charging device, such as a foldable solar panel or a cylindrical solar panel, and thereby charged directly. Hence, the portable energy-storage device of the present invention is useful to mountaineers, campers, picnic goers, peddler-oriented markets, construction sites, ad hoc military commands, temporary venues, and disaster rescue centers. More importantly, the portable energy-storage device of the present invention can be “charged and used” instantly.

In another embodiment, the portable energy-storage devices of the present invention are connected in parallel to meet the demand for intensive power supply by using parallel connection lines to effectuate connection, wherein the parallel connection lines have the same interfaces (such as cigarette lighter plugs) at two ends, for example, connecting a positive pole to another positive pole and connecting a negative pole to another negative pole, so as to connect two energy-storage devices in parallel. In practice, the connection lines should be series-connected to a fuse with an appropriate resistance to provide device protection and current limiting. In a variant embodiment, if necessary, the parallel connection line is series-connected to a resistor for current-limiting, wherein the fuse is disposed inside the cigarette lighter plugs to ensure user safety and equalization of power levels between devices.

In yet another embodiment, the portable energy-storage devices of the present invention are series-connected to achieve different requirements of DC voltage, such as 12V, 24V, 36V, etc. The series connection line is in a specific form; one end of the series connection lines is merely connected to the negative pole, and the other end of the series connection lines is merely connected to the positive pole. The two plugs at the two ends are solely connected by one conducting wire and indicated by colors to identify the positive pole and the negative pole (black stands for the negative pole and red for the positive pole.) To cater to large output power of series-connected devices, it is feasible to connect series connection lines in parallel in order to provide a large output power. In practice, in order for the portable energy-storage devices of the present invention to operate well, a fuse must be disposed inside the plugs (such as cigarette lighter plugs) of the series connection lines so as to prevent wrong installation carried out on the part of users, and prevent short circuits situation.

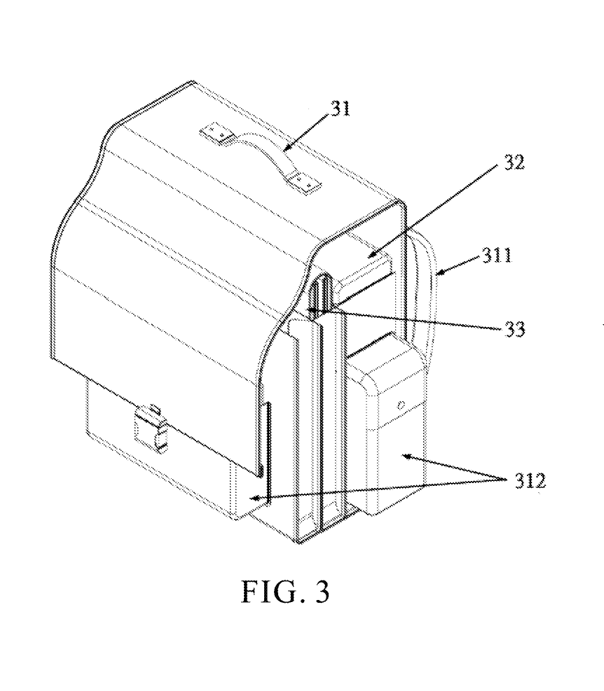

Practically, the portable energy-storage device of the present invention is coupled to a backpack or a handbag. Referring to FIG. 3, there is shown a perspective view of a portable energy-storage device 32 according to the second embodiment of the present invention. As shown in the diagram, in the second embodiment of the present invention, the portable energy-storage device 32 is for use with a backpack 31. The backpack 31 has straps 311 and multiple receiving spaces 312 of different sizes and contains constituent elements and accessories, such as a solar panel 33, power supply apparatuses or power conversion apparatuses for use with the portable energy-storage device 32. The solar panel 33 is either foldable or cylindrical. In the second embodiment of the present invention, the portable energy-storage device is usually for use at a venue which requires a power of 800W or less. Users can charge the portable energy-storage device of the present invention with sunlight or any appropriate energy source. Therefore, the portable energy-storage device in the second embodiment of the present invention is suitable for use by mountaineers, campers, picnic goers, peddler-oriented markets, construction sites, ad hoc military commands, temporary venues, disaster rescue centers, etc.

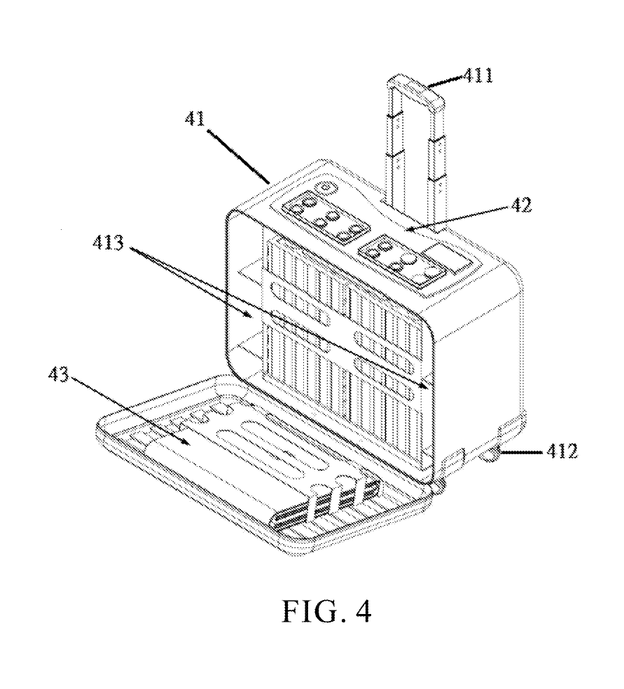

Furthermore, the portable energy-storage device of the present invention is coupled to a casing carried by a user. Referring to FIG. 4, there is shown a perspective view of a portable energy-storage device 42 according to the third embodiment of the present invention. In the third embodiment of the present invention, the portable energy-storage device 42 is for use with a casing 41. The casing 41 has a handle 411 and rollers 412 to enhance the portability of the portable energy-storage device 42 and, for example, comes in the form of a suitcase. The casing 41 contains constituent elements of the portable energy-storage device 42 and has a receiving space 413 which contains the peripheral apparatuses, such as a solar panel 43, power supply apparatuses, and power conversion apparatuses. In the third embodiment of the present invention, the portable energy-storage device 42 is usually for use at a venue which requires a power of 500W or more. Users can charge the portable energy-storage device of the present invention with sunlight or any appropriate energy source. Therefore, the portable energy-storage device 42 in the third embodiment of the present invention is suitable for use by mountaineers, campers, picnic goers, peddler-oriented markets, construction sites, ad hoc military commands, temporary venues, disaster rescue centers, etc.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A portable energy-storage device, comprising:
a battery module unit for storing and outputting electrical power;
a power switch unit connected to the battery module unit and adapted to enable or disable operations of the portable energy-storage device;
at least a universal I/O power interface unit connected to the power switch unit and adapted to not only output electrical power of the battery module unit but also receive and store electrical power in the battery module unit;
a power level monitoring unit connected to the power switch unit and adapted to monitor a power level of the battery module unit; and
a protection switch control unit connected to the battery module unit and the power level monitoring unit, wherein the power level monitoring unit signals the protection switch control unit to disable the operations of the portable energy-storage device so as to protect the portable energy-storage device against damage caused by at least one of under-discharging the battery module unit and over-charging the battery module unit.

2. The portable energy-storage device of claim 1, further comprising a power level display unit connected to the power level monitoring unit and adapted to display a power level status of the battery module unit.

3. The portable energy-storage device of claim 1, wherein the universal I/O power interface unit has a positive pole and a negative pole.

4. The portable energy-storage device of claim 1, wherein the universal I/O power interface unit is for use with one of a cigarette lighter plug, a USB plug and any appropriate power I/O conversion interface.

5. The portable energy-storage device of claim 1, wherein the portable energy-storage devices are connected in series.

6. The portable energy-storage device of claim 1, wherein the portable energy-storage devices are connected in parallel.

7. The portable energy-storage device of claim 1, wherein a backpack contains constituent elements of the portable energy-storage device.

8. The portable energy-storage device of claim 1, wherein a casing contains constituent elements of the portable energy-storage device.

9. The portable energy-storage device of claim 8, wherein the casing has a handle and rollers.

10. The portable energy-storage device of claim 1, wherein a solar panel is connected to the battery module unit through a standalone transmission interface or directly connected to the universal I/O power interface unit to supply power to the battery module unit.

11. The portable energy-storage device of claim 10, wherein the solar panel is foldable.

12. The portable energy-storage device of claim 10, wherein the solar panel is cylindrical.
